(19) United States
(12) Patent Application Publication
(10) Pub. No.: US 2003/0089783 A1
(43) Pub. Date: May 15, 2003

(54) Pen for use with devices comprising a touch-sensitive display device

(76) Inventor: Oliver Zechlin, Stein (DE)

Correspondence Address: BELL, BOYD & LLOYD, LLC, P. O. BOX 1135, CHICAGO, IL, 60690-1135, US

(21) Appl. No.: 10/275,245

(22) PCT Filed: May 2, 2001
(86) PCT No.: PCT/DE01/01655

(30) Foreign Application Priority Data
May 3, 2000 (EP) 100 21 500.9

(51) Int. Cl. G06K 7/10

(52) U.S. Cl. 235/472.03

(57) ABSTRACT

A pen for use with devices with a pen-based user surface is provided with a functional button which, when used, extends the possibilities of use of said pen e.g. like a mouse which comprises various buttons.

The invention relates to a pen for operating appliances having a touch-sensitive display device or input device and to an appliance having a touch-sensitive display device or input device which allows the appliance to be operated using a pen. Touch-sensitive displays and computers equipped with them, e.g. “palm-sized PCs”, “personal digital assistants” or communications terminals are usually operated using associated styli or pens, as with a writing implement.

This involves the user pressing the tip of the pen on particular points on the display device or input device or using the pen tip to describe particular contours on the touch-sensitive surface in order to select graphical objects displayed on the surface, i.e. to trigger an action which is symbolized by these graphical objects or in order to input characters, for example.

It is an object of the invention to improve such pens with the aim of making operation of the appliances more convenient. This object is achieved by means of an article in accordance with one of the independent patent claims. Advantageous developments of the invention are covered by subordinate patent claims.

The invention is described in more detail below using preferred exemplary embodiments and with reference to figures.

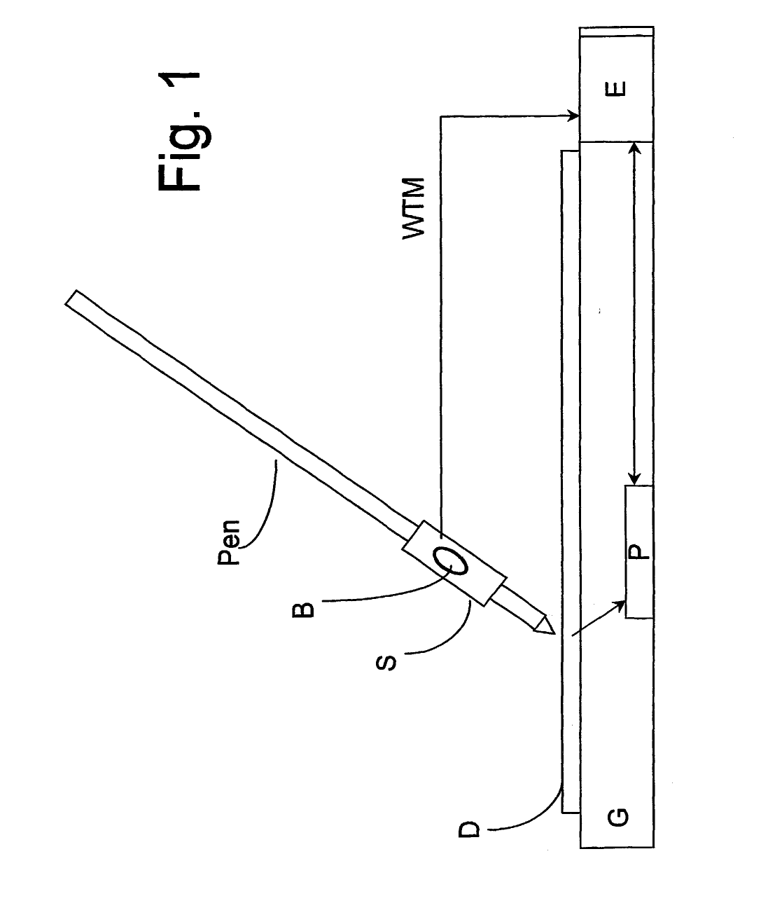

In this case, FIG. 1 shows a pen in line with one possible exemplary embodiment of the present invention, where the function key is incorporated in a transmitter fitted on the pen.

The user of the pen guides its pen tip over the input device or display device (D) on the appliance (G). In many appliances, the input device is simultaneously the display device as well; some appliances have the two produced separately. This difference is of no significance to the invention. In all cases, the input device is an essentially planar area on which the pen tip can be moved by the user. If the text below refers either just to the input device or just to the output device, this is usually to simplify the manner of expression. It is clear to a person skilled in the art from reading this description that the two terms can be substituted for one another so long as reference is not being made to a display device's display-specific attributes, which have nothing to do with the attributes of an input device.

In accordance with the present invention, the pen is fitted with a function key (B) which can be fitted on the surface of the pen or can be incorporated in the surface of the pen. FIG. 1 shows an advantageous exemplary embodiment of the invention in which the function key is incorporated in a transmitter (S) fitted on the pen. This solution is not the only conceivable type of implementation of the invention. However, since the function key (B) needs to control the transmitter (S) in some way so that the transmitter can transmit to the receiver a signal (WTM) corresponding to operation of the function key, it is very advantageous for the function key to be physically combined with the pen to form one unit.

The processor (P) in the appliance (G) evaluates the signal (WTM) received by the receiver (E). In this way, each action of the pen tip detected by the input device (D) can be assigned one of two or—depending on the form of the function key, i.e. depending on the number of possible states it has—more meanings. =p It is advantageous for the transmitter to be shaped such that it can easily—possibly also subsequently—be fitted on a pen for operating appliances having a touch-sensitive display device or input device. To this end, the transmitter housing can have a cylindrical hole, for example, through which the pen can be pushed. A suitable mechanism for locking the housing on the pen can be used to fix the transmitter at any point on the pen in this way. If the function key (B) is incorporated in the transmitter (S), the user can thus operate it very easily in a natural writing posture with the pen.

This allows the pen to be used in a similar manner to a mouse having a plurality of buttons. In numerous applications in information technology, the use of a “right-hand” mouse button has become customary. In an entirely similar manner, a pen in accordance with the invention could be used in conjunction with an appliance in accordance with the invention. It is thus possible to simplify complex operations, to “shorten” operating steps which are currently still necessary, or quite generally to allow new functions in a program or in an operating system.

The invention is also particularly suitable for use in conjunction with graphics tablets. The function key can also be assigned functions which are fixed but can be changed or selected by the user or are context-dependent, such as calling up a web browser or calling up macros (e.g. to format text in a particular style).

The following reference symbols and abbreviations have been used in the present description:

G Appliance

D Display or input device

S Transmitter

WTM Transmission of a signal from the pen to the appliance

E Receiver

P Processing unit

1. A pen for operating appliances (G) having a touch-sensitive display device (D) or input device (D),
characterized by
a function key (B) which is fitted on or incorporated in the surface of the pen or is fitted on the pen.

2. The pen as claimed in claim 1, having a transmitter (S) for transmitting (WTM) a signal indicating operation of the function key to the appliance.

3. The pen as claimed in claim 2, which has a transmitter and a function key in modular form fitted on it.

4. A transmitter (S) for transmitting (WTM) signals to an appliance (G), the shape and mechanical attributes of said transmitter being such that it can be fitted on a pen, for operating appliances having a touch-sensitive display device or input device.

5. The transmitter as claimed in claim 4, having an integrated function key (B) for controlling the signals which are to be transmitted to an appliance.

6. An appliance (G) having a touch-sensitive display device (D) or input device (D) which allows the appliance to be operated using a pen,
characterized by
a receiver (E) for receiving signals which can be transmitted (WTM) by a transmitter (S) on or in the pen.

7. The appliance as claimed in claim 6, having a processor unit (P) and software which is processed thereby and which interprets the signals received from the transmitter such that
operating a function key (B), which controls the signals to be transmitted from the transmitter to the appliance, together with the effect of the pressure of the pen tip acts like a second button on a mouse.
